(19) United States
(12) Patent Application Publication
(10) Pub. No.: US 2002/0178119 A1
(43) Pub. Date: Nov. 28, 2002

(54) Method and system for a role-based access control model with active roles

(75) Inventors: Patricia Diana Griffin, Austin, TX (US); Gary Cole, Driftwood, TX (US); Gregory Alan Wilson, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/864,392

(22) Filed: May 24, 2001

(51) Int. Cl. G06F 17/60; G06F 7/00

(52) U.S. Cl. 705/54; 707/1

(57) ABSTRACT

A method, system, apparatus, and computer program product are presented for managing access to resources with a role-based access control model that includes dynamic update functionality using role filters and capability filters. Rather than directly connecting individual users to a role, a role filter is defined for a role. The role filter is evaluated to determine which users should be matched to a given role, and matching users are then automatically associated with the given role. In addition to its role filter, each named role contains a set of capabilities. Each capability contains a set of access conditions and a capability filter. Each access condition has a set of rights. Rather than directly connecting individual resources to a capability, the administrator can define a capability filter for each capability. As target instances are added, deleted, or changed, capability filters are re-evaluated to maintain the appropriate set of relationships.

### BACKGROUND OF THE INVENTION

1. Field of the Invention

The present invention relates to an improved data processing system and, in particular, to a method and system for using a database. Still more particularly, the present invention provides a method and system for managing access to resources in accordance with a particular data model.

2. Description of Related Art

Security administration within distributed systems can be a difficult problem. Corporate personnel require access to applications and resources in a secure manner. However, over any given period of time, applications are installed and removed; corporate staff turnover results in the addition and removal of personnel, including temporary employees; resources are added, removed, or moved within organizations, both logically and physically; and projects are outsourced, thereby requiring limited access for contractors to an organization's data systems. Network interoperability also increases security risks such that the cost of mistakes in security administration can be significant.

Traditional security administration was platform-dependent—each type of computer system followed different rules for both administration and enforcement. Early network management tools for distributed systems attempted to show all possible resources and rights that needed security policy definitions. Traditional access control list (ACL) management models placed security settings on individual resources within the enterprise. In some organizations, security administration staff was tasked with managing lists of every allowable and forbidden relationship between resources, rights, and personnel, i.e. relationships between every element on one list to every element on each of the other lists. As information technology (IT) became more dynamic, IT administrative staff became overburdened.

During the last decade, an approach to scalable, error resistant, and auditable security administration was proposed, developed, and deployed by many enterprises: role-based access control (RBAC), also known as role-based administration or role-based authorization. In this approach, users are classified into groups in a manner similar to traditional security solutions. However, resources and access rights are also grouped into roles that reflect the various business processes or business responsibility sets that are common within the organization that is using the secure data processing system. Groups are then assigned multiple roles reflecting the work being done by the enterprise. In an administrative system that uses role-based access control, the administrator can be summarized in the following manner: define each role; define the capabilities of the role with respect to resources; connect users to one or more roles; and connect resources to one or more capabilities. Once defined, security policies can be automatically implemented on additions or updates to various databases for changes in personnel or resources based on the role-based access control relationships.

The definition of roles provides an extra layer of abstraction that improves the scalability, auditability, and quality of security administration staff. By using many different types of roles, the distinction between employees and contractors can be managed. Overall, role-based access control systems have improved security and service to end-users while also reducing the administrative cost of securely managing a growing enterprise.

Although security administration has been improved, role-based access control systems are not without significant administrative and cost considerations. Most enterprises are dynamic entities, and as the organization and business goals of an enterprise shift over time, the associated IT systems are expected to migrate without delays or errors. As an organization changes and/or grows, it can become difficult to manage and update the relationships between users and roles and the relationships between resources and capabilities.

Therefore, it would be advantageous to provide a method and system for automatically assisting in the management of a security administration system with role-based access control. It would be particularly advantageous to efficiently and automatically update a security administration system whenever an organization has a change within its personnel and its resources.

### SUMMARY OF THE INVENTION

A method, a system, an apparatus, and a computer program product are presented for managing access to resources with a role-based access control model that includes dynamic update functionality using role filters and capability filters, also termed “active roles”. Rather than having a security administrator specifically connect individual users to a role, a role filter is defined for a role. The role filter is evaluated to determine which users should be matched to a given role, and matching users are then automatically associated with the given role. Using role filters, one can create business rules for role-based resource access based on employee title, organization, job status, or project assignment.

In addition to its role filter, each named role contains a set of access capabilities. Each capability contains a set of access conditions and a capability filter. Each access condition has a set of rights and any qualifications or conditions to those rights. Similar to the operation of a role filter, capability filters can be used to describe the set of instances to which a particular capability should apply. Rather than having a security administrator specifically connect individual resources to a capability, the administrator can define a capability filter for each capability. As target instances are added, deleted, or changed, capability filters are re-evaluated to maintain the appropriate set of relationships.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a block diagram depicting a typical role-based access control system;

FIG. 3 is a block diagram depicting objects and relationships that include role filter and capability filter functionality in a role-based access control model in accordance with a preferred embodiment of the present invention; and

FIG. 4 is a flowchart showing some of the active role processing that occurs when updates are made to a database that is organized with the data relationships shown in FIG. 3 in accordance with a preferred embodiment of the present invention.

### DETAILED DESCRIPTION OF THE INVENTION

The present invention is directed to a system and a methodology for managing access to resources with a role-based access control model that includes “active roles”, which is a dynamic update mechanism. Prior to discussing the present invention in more detail, some background information is provided on the structure or organization of a distributed data processing system in which the present invention may be implemented.

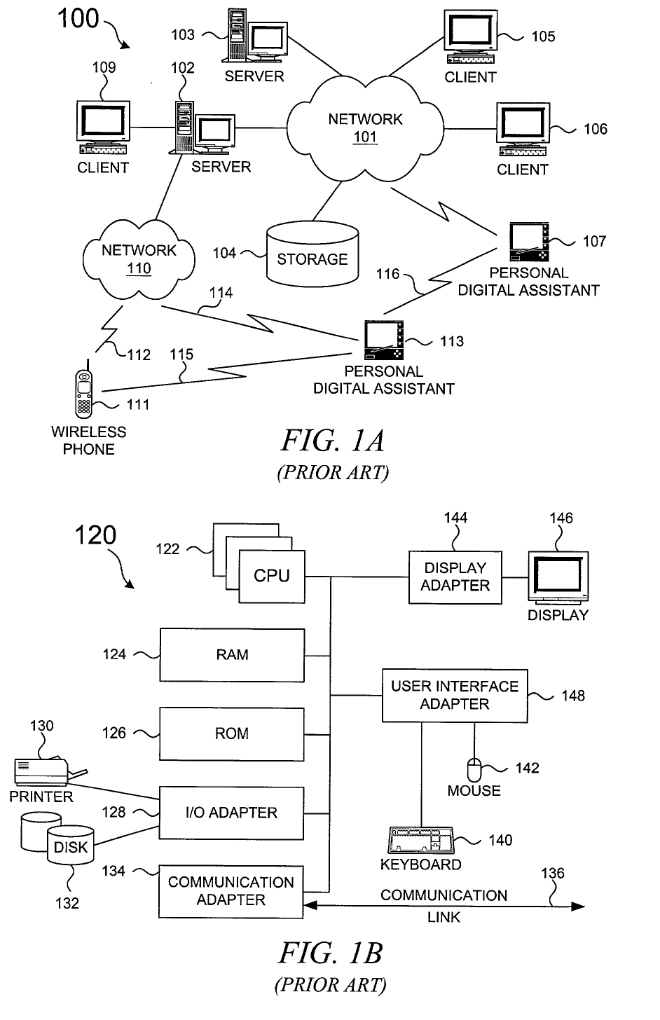

With reference now to the figures, FIG. 1A depicts a typical network of data processing systems, each of which may implement the present invention or a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 117 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a sound system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors and one or more types of non-volatile memory. Other peripheral devices may be used in addition to or in place of the hardware depicted in FIG. 1B. In other words, one of ordinary skill in the art would not expect to find similar components or architectures within a network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix™ operating system, while another device contains a simple Java™ runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

While the present invention will be described with reference to preferred embodiments in which object-oriented applications are utilized, the invention is not limited to the use of an object-oriented programming language. Rather, most programming languages could be utilized in an implementation of the present invention. In the preferred embodiment, though, Java Naming and Directory Interface (JNDI) application programming interfaces (APIs) are used to provide naming and directory functionality to system management functionality written using the Java programming language. The JNDI architecture consists of an API and a service provider interface (SPI). Java applications use the JNDI API to access a variety of naming and directory services, while the SPI enables a variety of naming and directory services to be plugged in transparently, thereby allowing a Java application using the JNDI API to access those services, which may include LDAP, Common Object Request Broker Architecture (CORBA) Common Object Services (COS) name service, and Java Remote Method Invocation (RMI) Registry. In other words, JNDI allows the system administration functionality of the present invention to be independent of any specific directory service implementation so that a variety of directories can be accessed in a common way.

It should also be noted that the present invention may be implemented, in part or in whole, using a distinction of client functionality versus server functionality. In other words, the data representations of objects may be manipulated either by a client or by a server, but the client and server functionality may be implemented as client and server processes on the same physical device. Thus, with regard to the descriptions of the preferred embodiments herein, client and server may constitute separate remote devices or the same device operating in two separate capacities. The data and application code of the present invention may be stored in local or distributed memory.

The present invention may be implemented on a variety of hardware and software platforms, as described above. More specifically, though, the present invention is directed to managing access to resources with a role-based access control model that includes dynamic update functionality using role filters and capability filters. As background, a typical role-based access control system is described before describing the present invention in more detail.

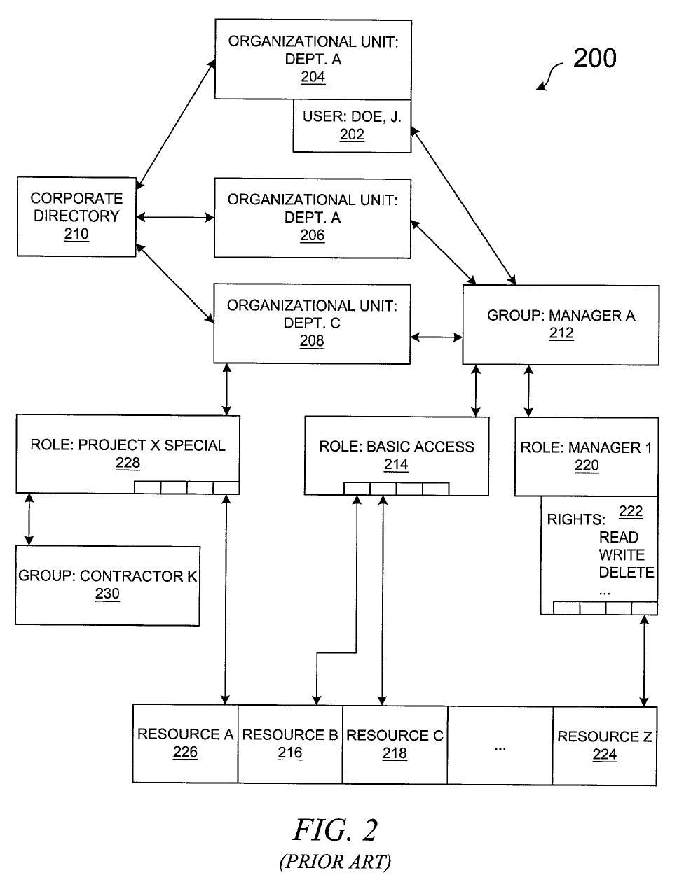

With reference now to FIG. 2, a block diagram depicts a typical role-based access control system. The elements shown within security management system 200 merely represent some of the general concepts, objects, relationships, or associations within a role-based access control system. Depending on the implementation of the security management system, the objects and relationships may have different names and functions.

Within an enterprise, an employee may “belong” to one or more organizational units, such as a department and a project. User object 202, which represents an employee, is associated with organizational object 204. Organizational objects 204-208 represent multiple organizational units within an enterprise, and each organizational unit is assumed to have multiple employees or users, and information about those employees are stored within corporate directory 210, which may be implemented as a data directory supported by one or more directory services.

User object 202 represents not only an employee but also a manager, so user object 202 is associated group object 212, which represents a group of similar managers. In FIG. 2, organizational unit objects 206 and 208 are shown as being associated with group object 212. It may be assumed that each organizational unit within the enterprise has a manager of the type represented by group object 212, although the specific employees within the organizations represented by objects 206 and 208 are not specifically identified in the diagram.

Depending on an employee's title or job description within the enterprise, an employee may be assigned one or more roles within the security management/administration system. Group object 212 is associated with role object 214, which defines a role having basic access rights to resources 216 and 218. For example, each employee of the enterprise may have access to certain types of basic computational resources, such as an intranet account for accessing an internal, enterprise-wide, Web site. This basic access is also applicable to each manager associated with group object 212, so group object 212 has been associated with role object 214; resource 216 might represent authorization to access a particular internal Web server, while resource 218 might represent authorization to access a firewall to the Internet.

However, each manager within the organization might require special privileges for accessing a corporate timekeeping application. In order to reflect actual business processes, role object 220 is defined and associated with group object 212, and role object 220 has a set of access rights 222 that determine exactly how any user associated with role object 220 can use resource 224, which might represent the timekeeping application.

The necessity of access rights can be illustrated by example. It can be assumed that the timekeeping application is used by different types of employees within the enterprise who have different authorized uses of the timekeeping application. Each department might have a timekeeper whose largest job function is keeping accurate account of job attendance, sick time, overtime pay, etc. A timekeeper role might be defined for each timekeeper, and the timekeeper receives certain authorized uses of, i.e. rights to, the timekeeping application.

The timekeeping application might have a function that allows the definition of corporate holidays, and timekeepers might be restricted from setting corporate holidays within the system. However, someone within the enterprise must configure the timekeeping application to recognize certain days as holidays, and this function might be restricted to managers. Hence, one set of the access rights associated with role object 220 is access rights 222 for special privileges within resource 224 representing the timekeeping function.

Organizational unit object 208 might represent a department that is working on a particular project that requires resource 226 available only to employees within the department. Hence, object 208, i.e. any user object associated with object 208, has been associated with role object 228, which has access rights to resource 226. Although not shown in the figure, any employee within the department would be represented by a user object that is associated with the organizational unit object, and each user object would eventually be associated with the role object representing basic resource access in addition to other role objects. More importantly, though, role object 228 shows a manner in which special roles can be instituted and managed. For example, external contractor employees could also be associated with group object 230, which in turn is associated with role object 228; contractor employees then have access to resource 226 while other employees within the enterprise do not. If another contractor company is hired to assist on the special project, then a new group can be formed for the new contractor's employees, and the new group can be quickly associated with the appropriate, predetermined, role objects, such as role object 228, without changes to other relationships and associations.

As shown with respect to the description of FIG. 2 above, a security administrator may be burdened within manually (through an appropriate management application) relating resources to roles within a prior art security administration system. The present invention is directed to providing a specific role-based access control model in which certain administrative duties can be automated using a methodology called “active roles”, as described below in more detail with respect to the other figures.

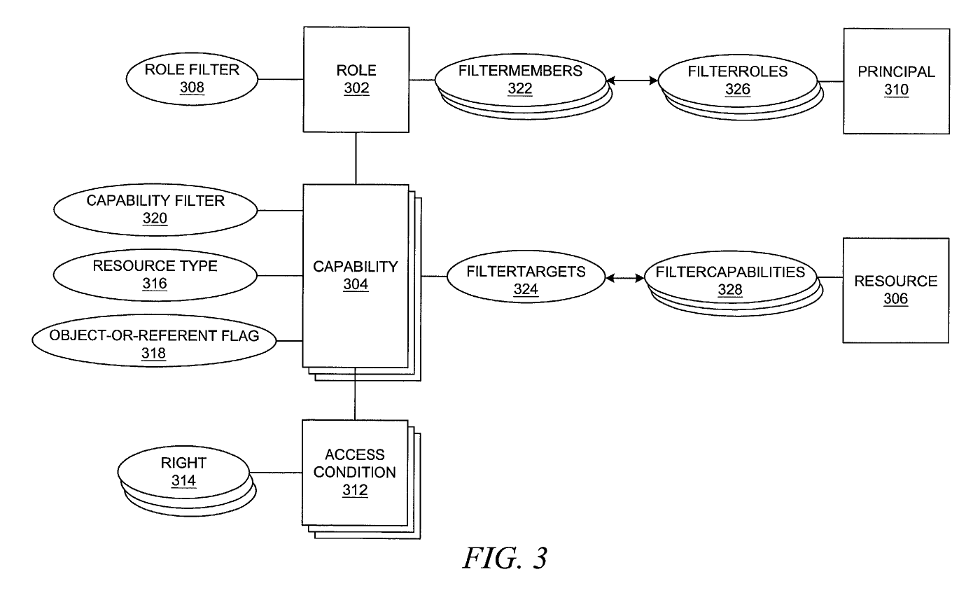

With reference now to FIG. 3, a block diagram depicts objects and relationships that include role filter and capability filter functionality in a role-based access control model in accordance with a preferred embodiment of the present invention. In a manner similar to prior art security management systems, the present invention uses the concepts of resources and roles. Resources, equivalently also referred to as targets, are systems, services, applications, devices, software/hardware components, data objects/records, etc., within an enterprise. A role is a characterization or categorization of entities, such as persons or services, via an abstraction of a function of the entity to which the role applies. However, an important issue with respect to the present invention is control of secure access to protected resources on behalf of certain users, groups of users, services, etc., so as to efficiently manage relationships with respect to potentially thousands of users and thousands of resources that may be in a continual state of change. Hence, the present invention extends the concepts of resource and role as described in more detail herein.

In the present invention, a role, such as role 302, is composed of a set of one or more capabilities, such as capability 304, that define access to a specific set of resources, such as resource 306. A role can have a filter, such as role filter 308, that can be evaluated to determine the list of principals, such as principal 310, to assign to the role. In other words, a role filter determines the set of principals to which a role should apply.

A principal represents a potential consumer of resources, which may include a user, an application, a service, or another type of resource consumer. Assuming that the present invention is implemented in an object-oriented manner, a principal object is a broader class of object than an individual user object. Most commonly, an instance of a principal would be a person or an application.

Filters are composed of expressions containing attribute conditions. For role filters, the attributes that are used by a filter expression are particular to principals and subclasses of principals. In the present invention, the syntax of the filters is preferably compliant with a Request for Comments (RFC) standard promulgated by the Internet Engineering Task Force (IETF), specifically RFC 2254, “The String Representation of LDAP Search Filters”, which defines a common filter syntax.

A capability is composed of a set of one or more access conditions, such as access condition 312, each of which has a set of one or more rights, such as right 314. The access conditions define certain access criteria, such as time-of-day constraints. For example, if a resource is a logon authentication application, certain users may be limited to logging onto a system only within certain hours. The rights are access types described in simple terms as appropriate for the particular type of resource, such as read, write, execute, and delete. The presence of one right may imply other rights. For instance, for a particular type of object, write access may imply delete access as well.

A capability has two additional qualifiers: a resource type 316 and Object-or-Referent flag 318. Each capability defines access to a different type of resource, as indicated by the resource type qualifier. Assuming that the present invention is implemented in an object-oriented manner, a “targetObjClass” attribute may be used to define the resource type; a targetObjClass attribute can refer to an Windows® NT-class server, file, printer, and other computational resources, or even another capability, role, or principal.

It should be noted that a role does not have a corresponding “targetObjClass” attribute because a role is always associated with a principal. Although a principal may be subclassed for different types of entities, a role filter is always evaluated against principals. From one perspective, the “targetObjClass” of a role is implied as being a principal.

The Object-or-Referent flag within a capability, which programmatically might be called an “ObjectOrReferent” flag, defines the type of access: object access or reference access. Object access refers to access to information about the resources in the datastore, whereas referent access refers to physical access to the resources. The importance of the difference between the two types of access can be illustrated by examples. A particular person may have a role, such as printer technician, that has two capabilities with respect to a printer device resource: one capability allows the printer technician to obtain all data about the printer device, in which case the capability would have object access; another capability allows the printer technician to have physical access to the printer device in order to submit print jobs to the printer device. Another particular person may have a role, such as computer programmer, that has one capability with respect to the printer device resource: a capability that allows the computer programmer to have physical access to the printer device in order to submit print jobs to the printer device.

In a manner similar to that described above with respect to a role, a capability can have a filter, such as capability filter 320, that can be evaluated to determine the list of resources to which the capability defines access. In other words, a capability filter can be used to determine the set of resources to which a particular capability should apply. Rather than specifically, manually, connecting individual resources to a capability, as in prior art systems, a system user, such as a security administrator, can use the present invention to define a capability filter for each capability. As resource instances are added, deleted, or modified, the capability filter is re-evaluated and used to maintain the appropriate set of relationships.

Again, filters are composed of expressions containing attribute conditions; for capability filters, the attributes that are used by a filter expression are particular to the type of resource defined by the capability's resource type (targetobjClass). For example, if the targetObjClass represents a person, the attributes referenced in the filter might be attributes such as address, surname, or title.

A resource can be any object in the system, including any instance of a principal, role, or capability. Therefore, a capability with object access would allow the following scenario. A particular person may have a role, such as printer technician manager, that has a superset of the capabilities of the role of printer technician. In addition to having complete access to printer device resources, the printer technician manager may have capabilities with respect to printer technicians: the printer technicians are resources against which the printer technician manager can have object access to obtain all information about the printer technicians.

Active role processing examines additions, deletions, and modifications of a particular instance (role, capability, principal, or resource) and/or the attributes of the particular instance, retrieves the filters related to the particular instance type, and “runs” the filters against the particular instance, which may result in changes to one or more membership lists. In other words, any change to any instance results in an identification of the filters that are associated with the instance, and the identified filters are run against the instance.

If a filter is added or modified, the filter is run against all applicable instances, which may also result in changes to one or more membership lists.

A membership list is a list of the instances that have been related to the instance containing the membership list. Membership lists are represented by a multivalued attribute within a role (filterMembers 322), a capability (filterTargets 324), a principal (filterRoles 326), and each class of object that can be a resource (filterCapabilities 328). There is a two-way relationship between filterMembers and filterRoles, and there is a two-way relationship between filterTargets and filterCapabilities, as follows:

When a principal is added to a role's filterMember attribute, the role is added to the principal's filterRole.

When a role is added to a principal's filterRole attribute, the principal is added to the role's filterMember attribute.

When a resource is added to a capability's filterTarget attribute, the capability is added to the resource's filterCapabilities attribute.

When a capability is added to a resource's filterCapabilities attribute, the resource is added to the capability's filterTarget attribute.

It should be noted that a role has either zero or one role filter; if the role does not have a role filter, it does not have any filterMembers and does not partake in active role processing. However, in this case, a role without a role filter may still be useful because a system user, such as a security administrator, can manually associate principals with roles via a management application, i.e. statically. Hence, other static attributes may be present within an instance of a role. Correspondingly, though, any associated principals that are related statically would not have any filterRoles for the role.

Similarly, it should be noted that a capability has either zero or one capability filter; if the capability does not have a capability filter, it does not have any filterTargets and does not partake in active role processing. However, in this case, a capability without a capability filter may still be useful because a security administrator or other user can manually associate resources with capabilities via a management application, i.e. statically. Hence, other static attributes may be present within an instance of a capability. Correspondingly, though, any associated resources that are related statically would not have any filterCapabilities for the capability.

As noted above, the present invention is preferably implemented in an object-oriented manner as follows. Active roles processing takes place in a Java-based directory server that stores and manages security-related data (users, accounts, roles, etc.). A client uses JNDI to request updates and retrievals from the server, and the server interfaces with a backend datastore (database or LDAP-compliant naming service) to service the requests. For each update to the database (except for changes to membership lists), active roles processing is invoked to analyze whether or not the update necessitates the regeneration of any of the membership lists described above. If so, the new lists are generated, and a call is made to the backend datastore to modify the attributes associated with the lists. It should be noted that the only changes that can be made to the membership lists originates with active role processing. Hence, if a request is made to update a membership list within the database, the requested update does not invoke further active role processing in order to prevent cycling within the active role processing.

Referring again to FIG. 3, roles, capabilities, and access conditions are represented by “Role”, “Capability”, and “AccessCondition” object classes in the system, respectively. A client instantiates an instance of an object class by creating a JNDI “Attributes” structure and sending a “bindo” request to the directory server to bind the “Attributes” to a name in the directory. For instance, to create an instance of the “Capability” object class, a user, such as a security administrator via a management application, would specify a name for the instance and also “Attributes” consisting of an “objClass” with a value of “Capability”, an RFC 2254-compliant filter, a “targetObjclass” attribute indicating the resource type of the resource to be related to the capability being created, and an “ObjectOrReferent” flag, as well as other possible attributes. The created “Capability” object is then “bound” to an existing “Role” object in the system.

A “Principal” is an abstract object class. It cannot be instantiated directly, but its subclasses (e.g., “Person”, “Service”) can be. A “Resource” is not a real object class because any object class can be a resource. Conceptually, however, an instance becomes a resource when it becomes a target of a capability.

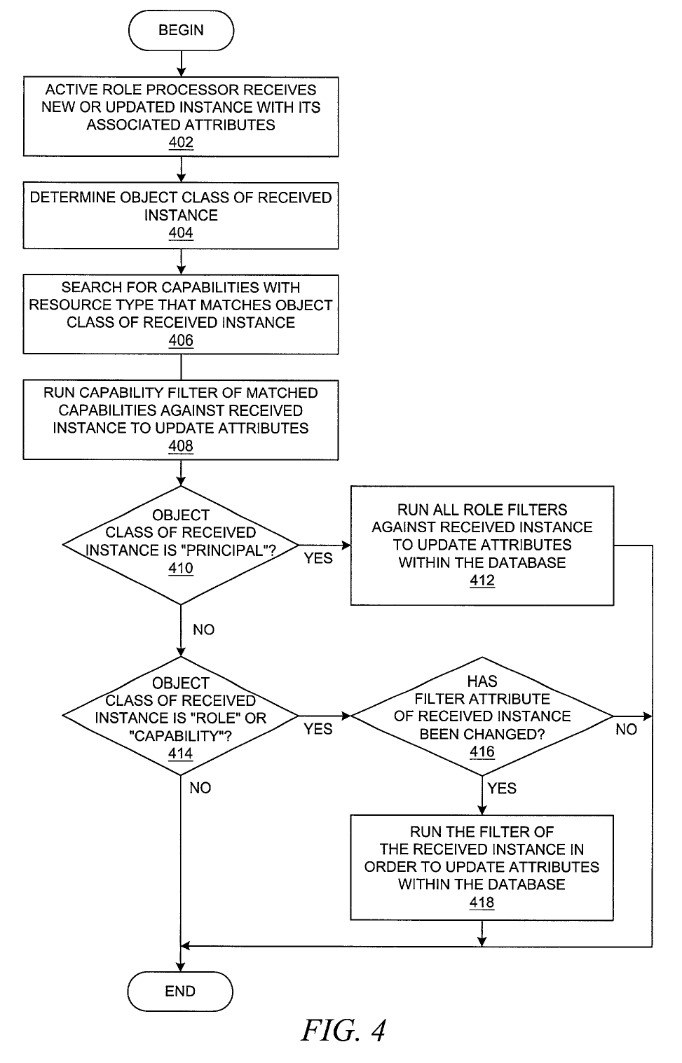

With reference now to FIG. 4, a flowchart shows some of the active role processing that occurs when updates are made to a database that is organized with the data relationships shown in FIG. 3 in accordance with a preferred embodiment of the present invention. The process shown in FIG. 4 is merely one pass through some of the considerations that might be triggered within an Active Role Processor module (which operates in conjunction with the directory or database) in response to an addition or modification of data within the database. It should be noted, however, that the Active Role Processor may operate in a daemon-like or monitoring manner such that its processing is executed repeatedly in a type of event loop.

The process begins when the Active Role Processor module receives an added or updated instance with its associated attributes (step 402). The Active Role Processor may receive a copy of the instance as a type of notification that some database-related action has occurred with respect to the instance. Alternatively, other data notification mechanisms may be used. The object class of the received instance is then determined (step 404), and a search is initiated for capabilities with a resource type that matches the object class of the received instance (step 406). Assuming that at least one capability is matched, the Active Role Processor then runs the capability filters of matched capabilities against the received instance (step 408), which results in the update of attributes in the database that may then be used during authorization processes to determine whether a requesting principal should receive access to a protected resource.

A determination is then made as to whether the object class of the received instance is of type “Principal” or any subclass of “Principal” (step 410). If so, then all role filters are run against the received instance (step 412), which results in the update of attributes in the database that may then be used during authorization processes to determine whether a requesting principal should receive access to a protected resource, and the active role processing with respect to this instance is complete. In this case, the process is determining which roles should be applied to the principal. Since roles can apply to all principals, all role filters must be evaluated. It should be noted that because some principals may be also be subject to capability filters, a new or modified principal may have resulted in filter processing with respect to both capability filters at step 408 and role filters at step 412.

If the object class of the received instance is not of type “Principal”, then a determination is made as to whether the object class of the received instance is of type “Role” or “Capability” (step 414). If not, then processing is complete. If so, then a determination is made as to whether the filter attribute of the received instance has changed, i.e. whether the filter is either new or modified (assuming that the instance has a filter) (step 416). If not, then the process is complete. If so, then the filter of the received instance is run in the appropriate manner (step 418), which results in the update of attributes in the database that may then be used during authorization processes to determine whether a requesting principal should receive access to a protected resource, and the process is complete. If the instance is of type “Role”, then the instance's role filter is run against all principals. If the instance is of type “Capability”, then the instance's capability filter is run against all resources with a matching resource type. In either case, the completion of this step may be computationally expensive if the system has defined many thousands or millions of principals or resources.

The advantages of the present invention should be apparent in view of the detailed description of the invention that is provided above. In the prior art, role-based access control models used the concept of roles to automate processing associated with users and their associated groups. Although security management applications had been improved through the use of role-based access control models, these previous systems still placed burdensome management tasks on security administrators.

In contrast, the present invention recognizes that significant improvements can be obtained by introducing novel concepts to role-based access control models. By incorporating a set of capabilities into a role in addition to access conditions and/or rights that were already associated with roles in prior art systems, the present invention enables automated processing to be performed with respect to the relationships between users and resources. Specifically, a role can have a role filter that is evaluated for matching users that are then automatically associated with the given role. In addition to its role filter, each named role contains a set of capabilities, each of which can have a capability filter. As target instances are added, deleted, or changed, capability filters are re-evaluated to maintain the appropriate set of relationships. By automatically managing the relationships between roles and users and the relationships between the role's capabilities and resources, the present invention provides a methodology for enhancing the ability of security administrators to provide secure access to resources by users.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the characteristics of the invention and its practical applications and to enable others of ordinary skill in the art to understand the invention in order to implement various embodiments with various modifications as might be suited to other contemplated uses.

What is claimed is:

1. A method for controlling access rights of a requesting principal to a protected resource in a computer system, wherein a principal is associated with at least one role, the method comprising:
associating a role filter with a role;
associating a set of one or more capabilities with the role;
associating a capability filter with a capability in the set of one or more capabilities; and
authorizing access for the requesting principal to the protected resource based on an association between the requesting principal and the role and based on an association between the protected resource and a capability of the role.

2. The method of claim 1 further comprising:
evaluating the role filter to determine a set of one or more principals to be associated with the role; and
evaluating the capability filter to determine a set of one or more resources to be associated with the capability.

3. The method of claim 1 further comprising:
associating a resource type with each capability in the set of one or more capabilities, wherein each capability defines access to at least one resource of the resource type.

4. The method of claim 1 further comprising:
associating a set of one or more access conditions with each capability in the set of one or more capabilities, wherein each access condition defines an access constraint against authorizing access for the requesting principal to the protected resource.

5. The method of claim 4 further comprising:
associating a set of one or more rights with each access condition in the set of one or more access conditions, wherein each right defines an access type for authorized access for the requesting principal to the protected resource.

6. The method of claim 1 further comprising:
associating a filterRoles list with the requesting principal, wherein the filterRoles list is a multivalued attribute containing a set of one or more roles;
associating a filterMembers list with the role, wherein the filterMembers list is a multivalued attribute containing a set of one or more principals;
adding the role to the filterRoles list associated with the requesting principal if the requesting principal is added to the filterMembers list associated with the role; and
adding the requesting principal to the filterMembers list associated with the role if the role is added to the filterRole list associated with the requesting principal.

7. The method of claim 1 further comprising:
associating a filterCapabilities list with a resource, wherein the filterCapabilities list is a multivalued attribute containing a set of one or more capabilities;
associating a filterTargets list with a capability, wherein the filterTargets list is a multivalued attribute containing a set of one or more resources;
adding the capability to the filterCapabilities list associated with the resource if the resource is added to the filterTargets list associated with the capability; and
adding the resource to the filterTargets list associated with the capability if the capability is added to the filterCapabilities list associated with the resource.

8. The method of claim 1 further comprising:
receiving notification of an update to an instance, wherein the instance has a type selecting from the group of “principal”, “resource”, “capability”, or “role”;
determining the type of the instance;
searching for capabilities with a resource type that matches the type of the instance; and
running capability filters of matched capabilities against the instance.

9. The method of claim 8 further comprising:
in response to a determination that the type of the instance is “principal”, running all role filters against the instance.

10. The method of claim 9 further comprising:
in response to a determination that the type of the instance is “role” or “capability”, determining whether a filter of the instance has been updated; and
in response to a determination that the filter of the instance has been updated, running the filter of the instance in accordance with the type of the instance.

11. An apparatus for controlling access rights of a requesting principal to a protected resource in a computer system, wherein a principal is associated with at least one role, the apparatus comprising:
means for associating a role filter with a role;
means for associating a set of one or more capabilities with the role;
means for associating a capability filter with a capability in the set of one or more capabilities; and
means for authorizing access for the requesting principal to the protected resource based on an association between the requesting principal and the role and based on an association between the protected resource and a capability of the role.

12. The apparatus of claim 11 further comprising:
means for evaluating the role filter to determine a set of one or more principals to be associated with the role; and
means for evaluating the capability filter to determine a set of one or more resources to be associated with the capability.

13. The apparatus of claim 11 further comprising:
means for associating a resource type with each capability in the set of one or more capabilities, wherein each capability defines access to at least one resource of the resource type.

14. The apparatus of claim 11 further comprising:
means for associating a set of one or more access conditions with each capability in the set of one or more capabilities, wherein each access condition defines an access constraint against authorizing access for the requesting principal to the protected resource.

15. The apparatus of claim 14 further comprising:
means for associating a set of one or more rights with each access condition in the set of one or more access conditions, wherein each right defines an access type for authorized access for the requesting principal to the protected resource.

16. The apparatus of claim 11 further comprising:
means for associating a filterRoles list with the requesting principal, wherein the filterRoles list is a multivalued attribute containing a set of one or more roles;
means for associating a filterMembers list with the role, wherein the filterMembers list is a multivalued attribute containing a set of one or more principals;
means for adding the role to the filterRoles list associated with the requesting principal if the requesting principal is added to the filterMembers list associated with the role; and
means for adding the requesting principal to the filterMembers list associated with the role if the role is added to the filterRole list associated with the requesting principal.

17. The apparatus of claim 11 further comprising:
means for associating a filterCapabilities list with a resource, wherein the filterCapabilities list is a multivalued attribute containing a set of one or more capabilities;
means for associating a filterTargets list with a capability, wherein the filterTargets list is a multivalued attribute containing a set of one or more resources;
means for adding the capability to the filterCapabilities list associated with the resource if the resource is added to the filterTargets list associated with the capability; and
means for adding the resource to the filterTargets list associated with the capability if the capability is added to the filterCapabilities list associated with the resource.

18. The apparatus of claim 11 further comprising:
means for receiving notification of an update to an instance, wherein the instance has a type selecting from the group of “principal”, “resource”, “capability”, or “role”;
means for determining the type of the instance;
means for searching for capabilities with a resource type that matches the type of the instance; and
means for running capability filters of matched capabilities against the instance.

19. The apparatus of claim 18 further comprising:
means for running all role filters against the instance in response to a determination that the type of the instance is “principal”.

20. The apparatus of claim 19 further comprising:
means for determining whether a filter of the instance has been updated in response to a determination that the type of the instance is “role” or “capability”; and
means for running the filter of the instance in accordance with the type of the instance in response to a determination that the filter of the instance has been updated.

21. A computer program product in a computer readable medium for use in a data processing system for controlling access rights of a requesting principal to a protected resource, wherein a principal is associated with at least one role, the computer program product comprising:
instructions for associating a role filter with a role;
instructions for associating a set of one or more capabilities with the role;
instructions for associating a capability filter with a capability in the set of one or more capabilities; and
instructions for authorizing access for the requesting principal to the protected resource based on an association between the requesting principal and the role and based on an association between the protected resource and a capability of the role.

22. The computer program product of claim 21 further comprising:
instructions for evaluating the role filter to determine a set of one or more principals to be associated with the role; and
instructions for evaluating the capability filter to determine a set of one or more resources to be associated with the capability.

23. The computer program product of claim 21 further comprising:
instructions for associating a resource type with each capability in the set of one or more capabilities, wherein each capability defines access to at least one resource of the resource type.

24. The computer program product of claim 21 further comprising:
instructions for associating a set of one or more access conditions with each capability in the set of one or more capabilities, wherein each access condition defines an access constraint against authorizing access for the requesting principal to the protected resource.

25. The computer program product of claim 24 further comprising:
instructions for associating a set of one or more rights with each access condition in the set of one or more access conditions, wherein each right defines an access type for authorized access for the requesting principal to the protected resource.

26. The computer program product of claim 21 further comprising:
instructions for associating a filterRoles list with the requesting principal, wherein the filterRoles list is a multivalued attribute containing a set of one or more roles;
instructions for associating a filterMembers list with the role, wherein the filterMembers list is a multivalued attribute containing a set of one or more principals;
instructions for adding the role to the filterRoles list associated with the requesting principal if the requesting principal is added to the filterMembers list associated with the role; and
instructions for adding the requesting principal to the filterMembers list associated with the role if the role is added to the filterRole list associated with the requesting principal.

27. The computer program product of claim 21 further comprising:
instructions for associating a filterCapabilities list with a resource, wherein the filterCapabilities list is a multivalued attribute containing a set of one or more capabilities;
instructions for associating a filterTargets list with a capability, wherein the filterTargets list is a multivalued attribute containing a set of one or more resources;
instructions for adding the capability to the filterCapabilities list associated with the resource if the resource is added to the filterTargets list associated with the capability; and
instructions for adding the resource to the filterTargets list associated with the capability if the capability is added to the filterCapabilities list associated with the resource.

28. The computer program product of claim 21 further comprising:
instructions for receiving notification of an update to an instance, wherein the instance has a type selecting from the group of “principal”, “resource”, “capability”, or “role”;
instructions for determining the type of the instance;
instructions for searching for capabilities with a resource type that matches the type of the instance; and
instructions for running capability filters of matched capabilities against the instance.

29. The computer program product of claim 28 further comprising:
instructions for running all role filters against the instance in response to a determination that the type of the instance is “principal”.

30. The computer program product of claim 29 further comprising:
instructions for determining whether a filter of the instance has been updated in response to a determination that the type of the instance is “role” or “capability”;
instructions for running the filter of the instance in accordance with the type of the instance in response to a determination that the filter of the instance has been updated.
